(19) United States
(12) Patent Application Publication
(10) Pub. No.: US 2019/0278989 A1
(43) Pub. Date: Sep. 12, 2019

(54) CONTROL DEVICE FOR IMAGE CAPTURING APPARATUS, IMAGE CAPTURING APPARATUS, AND METHOD OF CONTROLLING IMAGE CAPTURING APPARATUS

(71) Applicant: SHARP KABUSHIKI KAISHA, Sakai City (JP)

(72) Inventors: HIDEAKI OHTSUKI, Sakai City (JP); YOSHIRO ISHIKAWA, Sakai City (JP)

(21) Appl. No.: 16/289,414

(22) Filed: Feb. 28, 2019

(30) Foreign Application Priority Data
Mar. 7, 2018 (JP) 2018-041091

(51) Int. Cl. G06K 9/00; B25J 9/16

(52) U.S. Cl. CPC G06K 9/00664; B25J 9/1664; G06K 9/00637

(57) ABSTRACT

The present invention saves the trouble of having to carry an image capturing apparatus to a spot suitable for shooting a landmark. Provided is a control device including: a location identifying section configured to identify a current location of a robot; a landmark information specifying section configured to specify (i) a landmark for which a spot suitable for shooting the landmark is present at or near the current location and (ii) the spot suitable for shooting the landmark; and a drive control section configured to cause the robot to move to the spot suitable for shooting the landmark thus specified.

This Nonprovisional application claims priority under 35 U.S.C. § 119 on Patent Application No. 2018-041091 filed in Japan on Mar. 7, 2018, the entire contents of which are hereby incorporated by reference.

### TECHNICAL FIELD

The present invention relates to a control device for an image capturing apparatus, an image capturing apparatus, and a method of controlling an image capturing apparatus.

### BACKGROUND ART

Patent Literature 1 discloses an image capturing apparatus that provides guidance for effective shooting of a landmark even in a case where a user does not have any information about a photo shooting location in advance. This image capturing apparatus includes: a current location obtaining means for obtaining a current location; and an information storing means for recording thereon location information of landmarks and information about photo spots for the landmarks.

The image capturing apparatus further includes: an extracting means for searching the information storing means to find a landmark near the obtained current location and extracting information about a photo spot associated with the found landmark; and a displaying means for displaying information about the photo spot.

### CITATION LIST

### Patent Literature

### Patent Literature 1

Japanese Patent Application Publication Tokukai No. 2011-188054 (Publication date: Sep. 22, 2011)

### SUMMARY OF INVENTION

### Technical Problem

However, the above conventional technique has an issue in that, in order to shoot a landmark from a suitable spot, it is necessary for a user to carry the image capturing apparatus to the spot suitable for shooting and that this is troublesome.

One or more embodiments of the present invention were made in view of the above issue, and an object thereof is to provide a control device for an image capturing apparatus which is capable of saving the trouble of having to carry the image capturing apparatus to a spot suitable for shooting a landmark, and the like.

### Solution to Problem

In order to attain the above object, a control device for an image capturing apparatus according to one or more embodiments of the present invention is a control device for an image capturing apparatus that includes a camera device, the control device including: a location identifying section configured to identify a current location of the image capturing apparatus; a landmark information specifying section configured to specify (i) a landmark for which a spot suitable for shooting the landmark is present at or near the current location and (ii) the spot suitable for shooting the landmark; and a drive control section configured to cause the image capturing apparatus to move to the spot suitable for shooting the landmark thus specified.

In order to attain the above object, an image capturing apparatus according to one or more embodiments of the present invention is an image capturing apparatus including: at least one location information obtaining device; at least one memory device; at least one driver device; at least one movable part; at least one camera device; and at least one control device, the at least one memory device storing therein landmark information in which landmarks are associated with locations of the respective landmarks and with spots suitable for shooting the landmarks, the at least one control device being configured to identify a current location of the image capturing apparatus on the basis of current location information obtained by the at least one location information obtaining device, specify, by referencing the landmark information stored in the at least one memory device, (i) a landmark for which a spot suitable for shooting the landmark is present at or near the current location and (ii) the spot suitable for shooting the landmark, and cause, by causing the at least one driver device to instruct the at least one movable part to carry out an action, the image capturing apparatus to move to the spot suitable for shooting the landmark thus specified.

In order to attain the above object, a method of controlling an image capturing apparatus according to one or more embodiments of the present invention is a method of controlling an image capturing apparatus that includes a camera device, the method including: a location identifying step including identifying a current location of the image capturing apparatus; a landmark information specifying step including specifying (i) a landmark for which a spot suitable for shooting the landmark is present at or near the current location and (ii) the spot suitable for shooting the landmark; and a drive control step inducing causing the image capturing apparatus to move to the spot suitable for shooting the landmark thus specified.

### Advantageous Effects of Invention

One or more embodiments of the present invention bring about an effect of making it possible to save the trouble of having to carry an image capturing apparatus to a spot suitable for shooting a landmark.

### BRIEF DESCRIPTION OF DRAWINGS

FIG. 1 shows block diagrams schematically illustrating a configuration of an image capturing apparatus (robot) in accordance with Embodiment 1 of the present invention.

FIG. 2 is a flowchart illustrating a flow of basic actions of the image capturing apparatus.

FIG. 3 is a flowchart illustrating a flow of actions of the image capturing apparatus.

FIG. 4 shows schematic diagrams illustrating positional relationships between the image capturing apparatus (terminal), a photo spot, and a landmark, and the like.

FIG. 5 illustrates one example of landmark information stored in a landmark database.

FIG. 6 shows block diagrams schematically illustrating a configuration of an image capturing apparatus (robot) in accordance with Embodiment 2 of the present invention.

FIG. 7 is a flowchart illustrating a flow of actions of the image capturing apparatus.

### DESCRIPTION OF EMBODIMENTS

### Embodiment 1

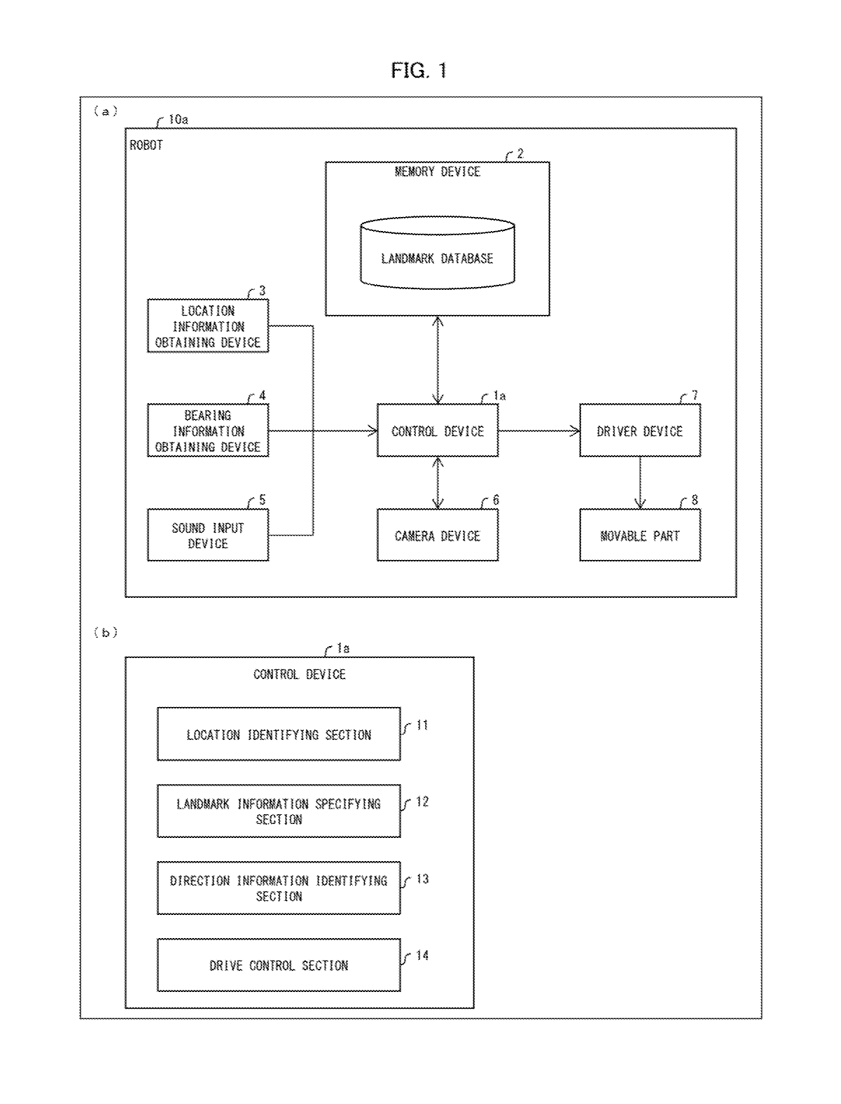

The following description will discuss one embodiment of the present invention in detail. As illustrated in (a) of FIG. 1, a robot (image capturing apparatus) 10a in accordance with Embodiment 1 includes: a control device 1a, a memory device 2, a location information obtaining device 3, a bearing information obtaining device 4, a sound input device 5, a camera device 6, a driver device 7, and a movable part 8. Note that the robot 10a may include one or more memory devices 2, one or more location information obtaining devices 3, one or more camera devices 6, one or more driver devices 7, one or more movable parts 8, and one or more control devices 1a.

The control device 1a includes, as illustrated in (b) of FIG. 1, a location identifying section 11, a landmark information specifying section 12, a direction information identifying section 13, and a drive control section 14. The control device 1a serves to determine and control actions of the robot 10a.

The location identifying section 11 identifies a current location of the robot 10a on map information on the basis of current location information related to the current location of the robot 10a obtained by the location information obtaining device 3. Next, the landmark information specifying section 12 specifies (i) a landmark for which a spot suitable for shooting the landmark is present at or near the current location and (ii) this spot suitable for shooting the landmark (hereinafter referred to as “photo spot” for short). Note that the landmark information specifying section 12 may be arranged to specify (i) a landmark present at or near the current location and (ii) a photo spot for that landmark.

The memory device 2 stores, in a landmark database therein, landmark information in which landmarks are associated with locations of the respective landmarks and with photo spots for the landmarks. The landmark database stores not only information concerning an area around the current location but also information about, for example, locations of landmarks (facilities and the like) all over the country, like a car navigation system. In this arrangement, for example, the landmark information specifying section 12 references the landmark information stored in the memory device 2 to specify the landmark and the photo spot(s) therefor.

The direction information identifying section 13 identifies (i) a range of shooting direction of the camera device 6 (this range is the range of vision that is seen in an image captured by the camera device 6) and (ii) a direction to the landmark as seen from the photo spot. For example, the direction information identifying section 13 references information about the photo spot and information about the location of the landmark contained in the landmark information to specify the direction to the landmark as seen from the photo spot.

The drive control section 14 causes the driver device 7 to instruct the movable part 8 to carry out an action, thereby causing the robot 10a to move to the foregoing specified photo spot. According to the above arrangement, it is possible to cause the robot 10a to move to a photo spot suitable for shooting a landmark. This makes it possible to save the trouble of having to carry the robot 10a to the photo spot for the landmark.

The drive control section 14, after causing the driver device 7 to drive the movable part 8 to thereby cause the robot 10a to move to the photo spot, adjusts the orientation of the robot 10a so that the specified range of shooting direction matches the direction to the landmark as seen from the photo spot (i.e., so that the direction to the landmark as seen from the photo spot is included within the range of vision that is seen in an image captured by the camera device 6).

According to the above arrangement, it is possible to automatically cause the range of shooting direction of the camera device 6 and the direction to the landmark as seen from the photo spot to match each other (i.e., automatically carry out a control such that the direction to the landmark as seen from the photo spot is included within the range of vision that is seen in an image captured by the camera device 6), and therefore it is possible to save the user's trouble of having to adjust the orientation of the robot 10a. Note that the range of shooting direction and the direction to the landmark do not necessarily have to precisely match each other, provided that the range of shooting direction is such that the landmark shows up in a captured image.

The memory device 2 is a memory that stores therein the landmark database, programs, processing data, and the like. The landmark database is a database that includes landmark names, location information items, photo spot information items, and shooting direction information items. Note that, although Embodiment 1 exemplarily discusses an arrangement in which the memory device 2 of the robot 10a stores therein the landmark database, programs, processing data, and the like, such information, programs, and data may be stored on an external server communicable with the robot 10a.

The location information obtaining device 3 is constituted by a global positioning system (GPS) receiver or the like, and obtains current location information related to the current location of the robot 10a. The bearing information obtaining device 4 is constituted by a magnetic field sensor or the like, and obtains information related to the orientation (or bearing) of the robot 10a.

The sound input device 5 is a device via which a user's speech (e.g., request for shooting) is input, and is, for example, a microphone. The camera device 6 is a device that carries out image capturing in accordance with an instruction from the control device 1a, and is, for example, a digital camera.

The driver device 7 serves to drive the movable part 8 in accordance with an instruction from the control device 1a, and is, for example, a servomotor. The movable part 8 is a part that is movable to cause the robot 10a to move, change the orientation of the robot 10a, change the posture of the robot 10a to cause the robot 10a to hold a pose, and/or the like, and is, for example, a leg, an arm, a neck, or the like of the robot 10a.

(Basic Actions of Robot)

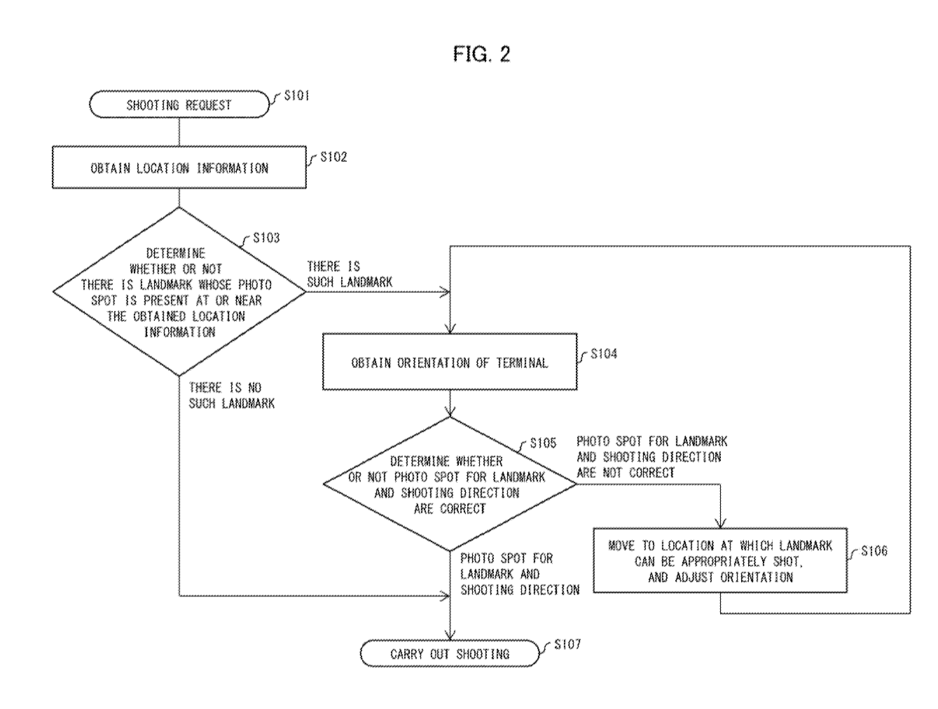

The following description will discuss a flow of basic actions of the robot 10a with reference to a flowchart illustrated in FIG. 2. First, in step S101 (“step S” is hereinafter referred to as “S” for short), a user's speech related to a request for shooting is input via the sound input device 5, and the process proceeds to S102.

In S102, the location information obtaining device 3 obtains information related to the current location of the robot 10a (this information is location information), and the location identifying section 11 identifies the location of the robot 10a on map information on the basis of the location information (location identifying step). Then, the process proceeds to S103.

In S103, the landmark information specifying section 12 reads landmark information from the landmark database, and specifies (i) a landmark whose photo spot is present at or near the above current location and (ii) this photo spot (landmark information specifying step). The control device la references information which is read from the landmark database and which is related to photo spots for landmarks to determine whether or not there is a landmark whose photo spot is present at or near the current location of the robot 10a. If it is determined that there is such a landmark, the process proceeds to S104. On the other hand, if it is determined that there is no such landmark, the process proceeds to S107 and shooting is carried out.

In S104, direction information related to the orientation of the robot 10a is obtained via the bearing information obtaining device 4, and the direction information identifying section 13 identifies, on the basis of the direction information, the orientation (range of shooting direction) of the robot 10a on the map information, and the process proceeds to S105.

In S105, the landmark information specifying section determines whether or not the photo spot for the landmark and shooting direction are correct. If it is determined that the photo spot for the landmark and shooting direction are correct, the process proceeds to S107 and shooting is carried out. On the other hand, if it is determined that the photo spot for the landmark and shooting direction are not correct, the process proceeds to S106.

In S106, the drive control section 14 causes the driver device 7 to drive the movable part 8 to cause the robot 10a to move to a location at which the landmark can be appropriately shot (this location is the photo spot) (drive control step). Furthermore, the drive control section 14, after causing the driver device 7 to drive the movable part 8 and thereby causing the robot 10a to move to the photo spot, adjusts the orientation of the robot 10a so that the specified range of shooting direction and the direction to the landmark as seen from the photo spot match each other.

(Details of Actions of Robot in Accordance with Embodiment 1)

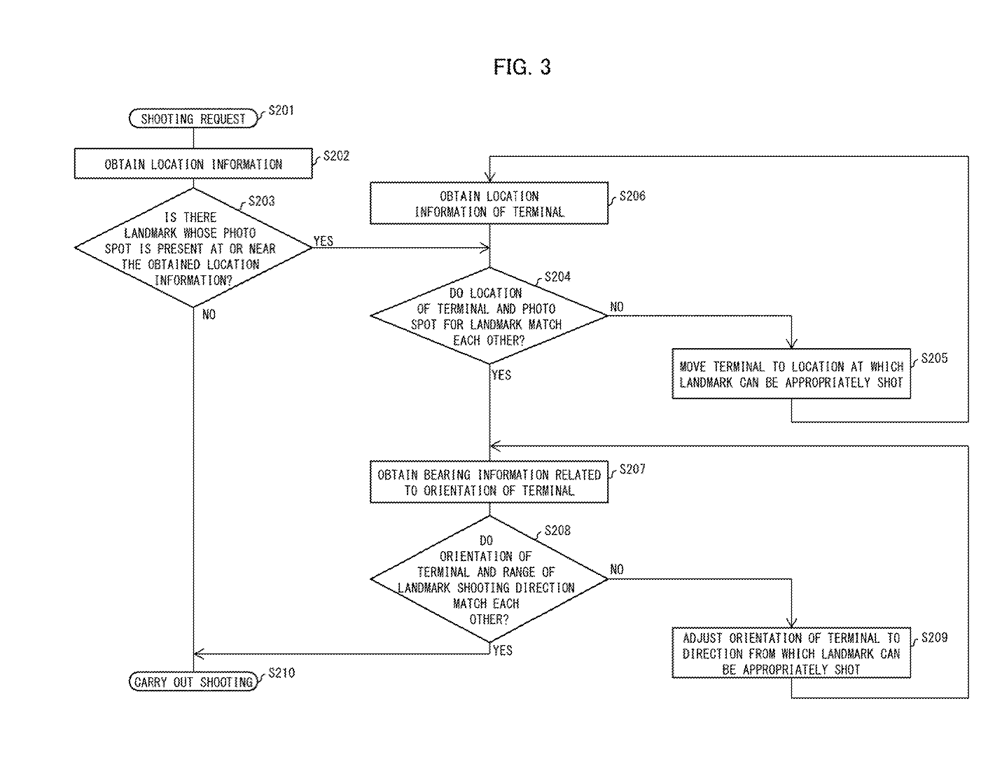

The following description will discuss details of actions of the robot 10a in accordance with Embodiment 1 with reference to a flowchart illustrated in FIG. 3. In S201, a user's speech related to a request for shooting is input via the sound input device 5 and, upon reception of the request for shooting, the process proceeds to S202.

In S202, the location information obtaining device 3 obtains information related to the current location of the robot 10a (this information is location information), and the location identifying section 11 identifies the location of the robot 10a on map information on the basis of the location information. Then, the process proceeds to S203.

In S203, the landmark information specifying section 12 reads landmark information from the landmark database, and specifies (i) a landmark whose photo spot is present at or near the above current location and (ii) this photo spot. The control device 1a references information which is read from the landmark database and which is related to the photo spot for the landmark to determine whether or not there is a landmark whose photo spot is present at or near the current location of the robot 10a. If it is determined that there is such a landmark, the process proceeds to S204. On the other hand, if it is determined that there is no such landmark, the process proceeds to S210 and shooting is carried out.

In S204, the control device 1a references the landmark information in the landmark database to check whether or not the current location of the robot 10a matches the photo spot for the landmark. If it is determined that the current location of the robot 10a matches the photo spot for the landmark, the process proceeds to S207. On the other hand, if it is determined that the current location of the robot 10a does not match the photo spot for the landmark, the process proceeds to S205.

In S205, the control device 1a references the landmark information in the landmark database to calculate a difference between the latitude/longitude of the photo spot for the landmark and the latitude/longitude (current location) of the robot 10a, provides the driver device 7 with an instruction of an action corresponding to the difference through use of the drive control section 14, and thereby causes the movable part 8 to operate and causes the robot 10a to move (walk). Then, the process proceeds to S206.

In S206, the location information obtaining device 3 obtains information related to the current location of the robot 10a (this information is location information), and the location identifying section 11 identifies the location of the robot 10a on map information on the basis of the location information. Then, the process proceeds to S204.

In S207, the direction information related to the orientation of the robot 10a is obtained via the bearing information obtaining device 4, and the direction information identifying section 13 identifies, on the basis of the direction information, the orientation (range of shooting direction) of the robot 10a on the map information, and the process proceeds to S208.

In S208, the control device 1a references the landmark information in the landmark database to check whether or not the orientation of the robot 10a matches the range of landmark shooting direction. If it is determined that the orientation of the robot 10a matches the range of landmark shooting direction, the process proceeds to S210 and shooting is carried out. On the other hand, if it is determined that the orientation of the robot 10a does not match the range of landmark shooting direction, the process proceeds to S209.

In S209, the control device 1a references the landmark information in the landmark database to calculate a difference between the range of landmark shooting direction and the orientation of the robot 10a, provides the driver device 7 with an instruction of an action corresponding to the difference through use of the drive control section 14, and thereby causes the movable part 8 to operate and causes the robot 10a to move (turn legs) to change orientation. Then, the process returns to S207.

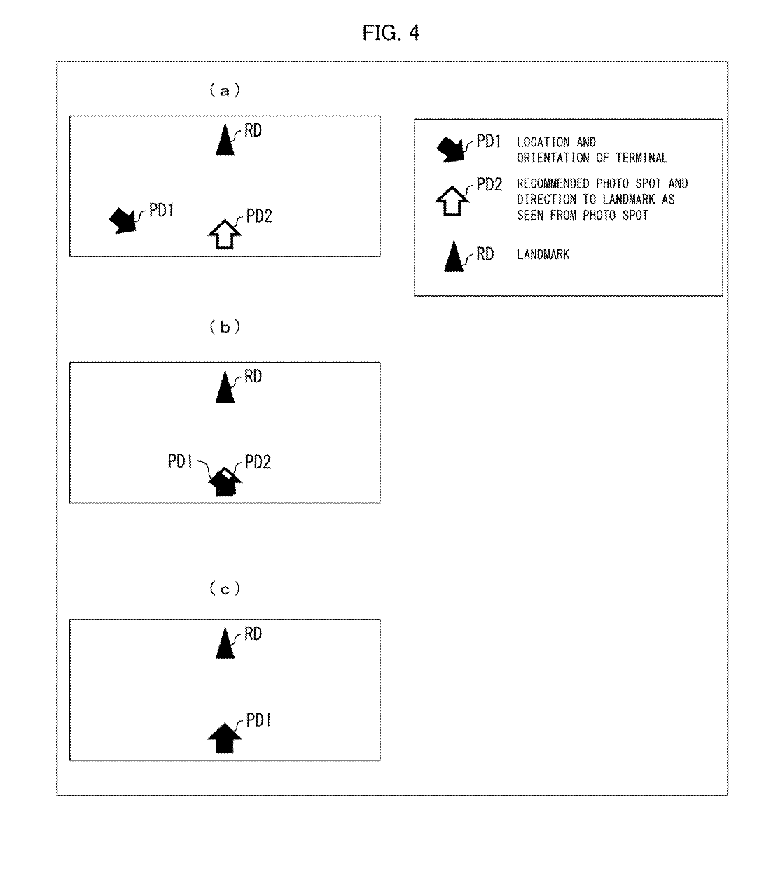

Next, FIG. 4 shows schematic diagrams illustrating positional relationships between the robot 10a (terminal), a photo spot, and a landmark, and the like. The symbol PD1 schematically represents the location and orientation (direction) of the robot 10a. The symbol PD2 schematically represents the location of a recommended photo spot and the direction to the landmark as seen from the photo spot. The symbol RD schematically represents the location of the landmark.

(a) of FIG. 4 illustrates a positional relationship between the landmark and the robot 10a, and illustrates a case in which “NO” is determined in the foregoing S204. (b) of FIG. 4 illustrates a case in which “YES” is determined in the foregoing S204 and “NO” is determined in the foregoing S208. (c) of FIG. 4 illustrates a case in which “YES” is determined in the foregoing S208.

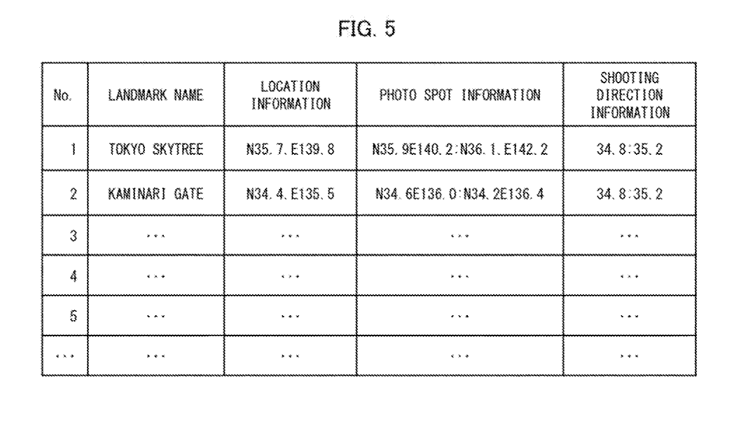

FIG. 5 illustrates one example of landmark information stored in the landmark database. The “LANDMARK NAME” indicates information related to the name of a landmark. The “LOCATION INFORMATION” indicates the location information of the landmark in terms of latitude/longitude. The “PHOTO SPOT INFORMATION” indicates a quadrangular range, and the “SHOOTING DIRECTION INFORMATION” indicates the range of shooting direction. Note that the data structure of the landmark information is not limited as such, and may alternatively be arranged in some other way. In the landmark information, each landmark may include a plurality of “PHOTO SPOT INFORMATION” items.

### Embodiment 2

The following description will discuss another embodiment of the present invention. For convenience of description, members having functions identical to those described in Embodiment 1 are assigned identical referential numerals and their descriptions are omitted.

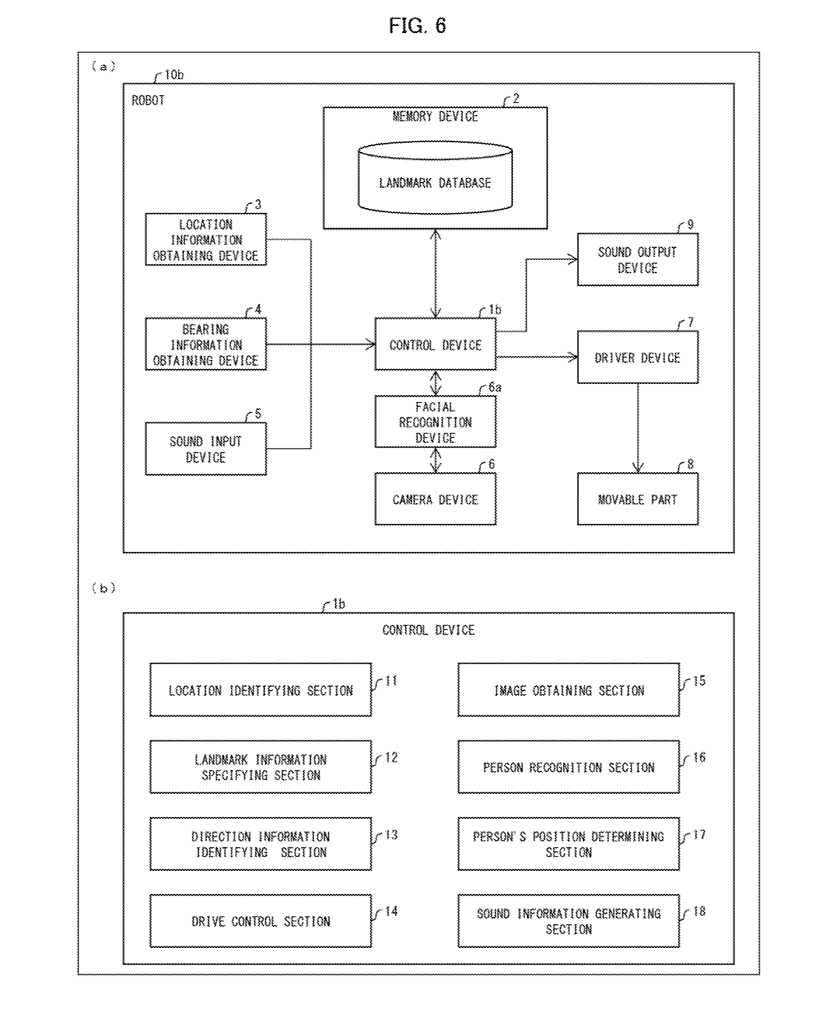

As illustrated in (a) of FIG. 6, a robot (image capturing apparatus) 10b in accordance with Embodiment 2 is different from the robot 10a in accordance with Embodiment 1 in that: the robot 10b includes a control device 1b in place of the control device 1a; a facial recognition device 6a is provided between the control device 1b and the camera device 6; and a sound output device 9 is further included. Note that the robot 10b may include one or more camera devices 6 and one or more control devices 1b.

Furthermore, as illustrated in (b) of FIG. 6, the control device 1b is different from that of the robot 10a in accordance with Embodiment 1 in that the control device 1b not only includes the same control blocks as those of the control device 1a but also includes an image obtaining section 15, a person recognition section 16, a person's position determining section 17, and a sound information generating section 18.

The image obtaining section 15 obtains a captured image captured by the camera device 6. The person recognition section 16 determines, on the basis of the result of facial recognition by the facial recognition device 6a, whether or not the captured image (e.g., through-the-lens image) contains a person's image (face).

The person's position determining section 17 determines whether or not the position of the person in the captured image is appropriate. The sound information generating section 18 generates, if it is determined that the position of the person in the captured image is not appropriate, sound information for guiding the person to move to an appropriate position. The sound information generating section 18 also outputs the generated sound information in the form of a sound via the sound output device 9. According to this arrangement, it is possible to take a picture in which a person and a landmark behind the person are in appropriate positional relationship.

(Details of Actions of Robot in Accordance with Embodiment 2)

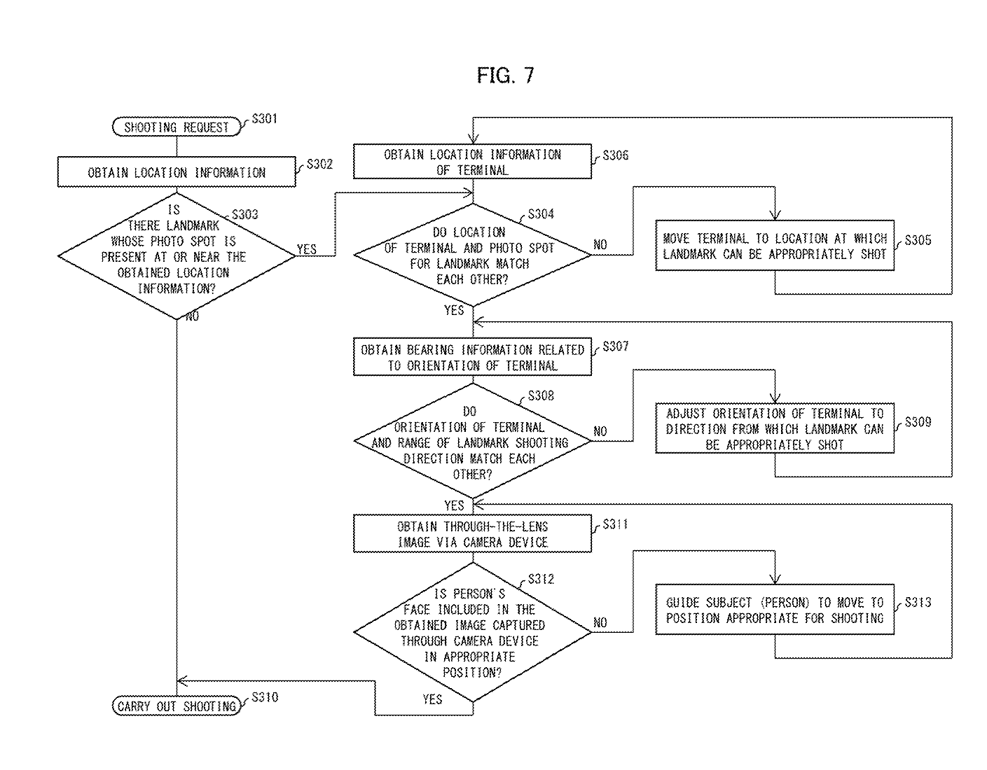

The following description will discuss details of actions of the robot 10b in accordance with Embodiment 2 with reference to a flowchart illustrated in FIG. 7. Note that the actions in S301 to S310 are the same as those in S201 to S210 in the flowchart illustrated in FIG. 3, and therefore descriptions therefor are omitted here.

The flowchart in accordance with Embodiment 2 is different from the flowchart illustrated in FIG. 3 in that the actions in S311 to S313 are added. Thus, the following description only discusses the actions in S311 to S313.

In S311, the image obtaining section 15 obtains a captured image (through-the-lens image) via the camera device 6, and the process proceeds to S312. In S312, the person's position determining section 17 determines whether or not a person's face is included in the obtained captured image in an appropriate position. More specifically, the person's position determining section 17 checks where in the captured image obtained by the facial recognition device 6a the person's face is present, and determines whether or not the position of the person's face is a position appropriate for shooting (for example, whether or not the person's face is substantially in the center of the image). If it is determined that the position of the person (face) is appropriate, the process proceeds to S310. On the other hand, if it is determined that the position of the person (face) is not appropriate, the process proceeds to S313.

In S313, the sound information generating section 18 generates sound information for guiding the person to move to the appropriate position. The sound information generating section 18 also outputs the generated sound information in the form of a sound via the sound output device 9. More specifically, the sound information generating section 18 guides a subject (person) to move to the appropriate position by outputting a speech from the sound output device 9. For example, in a case where the face appears large, the sound information generating section 18 guides the person to move away from the robot 10b, and, in a case where the face is only partially contained in the image, the sound information generating section 18 guides the person to move toward the center of the image.

Note that the actions discussed so far are based on the assumption that the shooting direction, view angle, and the like of the camera device 6 are kept constant.

[Embodiment 3: Software Implementation Example]

Control blocks of the control device 1a, 1b of the robot 10a, 10b (particularly, location identifying section 11, landmark information specifying section 12, direction information identifying section 13, drive control section 14, image obtaining section 15, person recognition section 16, person's position determining section 17, sound information generating section 18) can be realized by a logic circuit (hardware) provided in an integrated circuit (IC chip) or the like or can be alternatively realized by software.

In the latter case, the control device 1a, 1b of the robot 10a, 10b includes a computer that executes instructions of a program that is software realizing the foregoing functions. The computer includes, for example, at least one processor (control device) and also includes at least one computer-readable storage medium that stores the program therein. An object of the present invention can be achieved by the processor in the computer reading and executing the program stored in the storage medium. Examples of the processor include central processing units (CPUs). Examples of the storage medium include “a non-transitory tangible medium” such as a tape, a disk, a card, a semiconductor memory, and a programmable logic circuit, as well as a read only memory (ROM). The control device 1a, 1b of the robot 10a, 10b may further include a random access memory (RAM) or the like in which the program is loaded. The program can be supplied to or made available to the computer via any transmission medium (such as a communication network or a broadcast wave) which allows the program to be transmitted. Note that one or more embodiments of the present invention can also be achieved in the form of a computer data signal in which the program is embodied via electronic transmission and which is embedded in a carrier wave.

[Recap]

A control device for an image capturing apparatus in accordance with Aspect 1 of the present invention is a control device (1a, 1b) for an image capturing apparatus (robot 10a, 10b) that includes a camera device (6), the control device (1a, 1b) including: a location identifying section (11) configured to identify a current location of the image capturing apparatus; a landmark information specifying section (12) configured to specify (i) a landmark for which a spot suitable for shooting the landmark is present at or near the current location and (ii) the spot suitable for shooting the landmark; and a drive control section (14) configured to cause the image capturing apparatus to move to the spot suitable for shooting the landmark thus specified.

The above arrangement makes it possible to cause the image capturing apparatus to move to a spot which is suitable for shooting a landmark and which is present at or near the current location of the image capturing apparatus. This saves the trouble of having to carry the image capturing apparatus to the spot suitable for shooting the landmark.

A control device for an image capturing apparatus in accordance with Aspect 2 of the present invention may be arranged such that, in Aspect 1, the landmark information specifying section is configured to reference landmark information, in which landmarks are associated with locations of the respective landmarks and with spots suitable for shooting the landmarks, to specify (i) the landmark for which the spot suitable for shooting the landmark is present at or near the current location and (ii) the spot suitable for shooting the landmark.

A control device for an image capturing apparatus in accordance with Aspect 3 of the present invention may be arranged such that, in Aspect 2, the control device further includes a direction information identifying section configured to, after the image capturing apparatus has moved to the spot suitable for shooting the landmark, identify (a) a range of vision that is seen in a captured image captured by the camera device and (b) a direction to the landmark as seen from the spot suitable for shooting the landmark, and that the drive control section is configured to adjust an orientation of the image capturing apparatus so that the direction to the landmark as seen from the spot suitable for shooting the landmark is included in the range of vision that is seen in the captured image thus specified.

According to the above arrangement, it is possible to automatically carry out a control such that the direction to the landmark as seen from the spot suitable for shooting the landmark is included within the range of vision that is seen in the image captured by the camera device, and therefore it is possible to save the user's trouble of having to adjust the orientation of the image capturing apparatus.

A control device for an image capturing apparatus in accordance with Aspect 4 of the present invention may be arranged such that, in Aspect 3, the direction information identifying section is configured to reference (I) information indicative of the spot suitable for shooting the landmark and (II) information that is contained in the landmark information and that is indicative of a location of the landmark to identify the direction to the landmark as seen from the spot suitable for shooting the landmark.

A control device for an image capturing apparatus in accordance with Aspect 5 of the present invention may be arranged such that, in any of Aspects 1 to 4, the control device further includes: an image obtaining section configured to obtain a captured image captured by the camera device; a person's position determining section configured to, in a case where an image of a person is contained in the captured image thus obtained, determine whether or not a position of the person in the captured image is appropriate; and a sound information generating section configured to, in a case where it is determined that the position of the person in the captured image is not appropriate, output sound information for guiding the person to move to an appropriate position. According to this arrangement, it is possible to take a picture in which a person and a landmark behind the person are in appropriate positional relationship.

An image capturing apparatus in accordance with Aspect 6 of the present invention is an image capturing apparatus (robot 10a, 10b) including: at least one location information obtaining device (3); at least one memory device (2); at least one driver device (7); at least one movable part (8); at least one camera device (6); and at least one control device (1a, 1b), the at least one memory device storing therein landmark information in which landmarks are associated with locations of the respective landmarks and with spots suitable for shooting the landmarks, the at least one control device being configured to identify a current location of the image capturing apparatus on the basis of current location information obtained by the at least one location information obtaining device, specify, by referencing the landmark information stored in the at least one memory device, (i) a landmark for which a spot suitable for shooting the landmark is present at or near the current location and (ii) the spot suitable for shooting the landmark, and cause, by causing the at least one driver device to instruct the at least one movable part to carry out an action, the image capturing apparatus to move to the spot suitable for shooting the landmark thus specified. According to the above arrangement, it is possible to obtain similar effects to those of Aspect 1.

A method of controlling an image capturing apparatus in accordance with Aspect 7 of the present invention is a method of controlling an image capturing apparatus that includes a camera device, the method including: a location identifying step including identifying a current location of the image capturing apparatus; a landmark information specifying step including specifying (i) a landmark for which a spot suitable for shooting the landmark is present at or near the current location and (ii) the spot suitable for shooting the landmark; and a drive control step inducing causing the image capturing apparatus to move to the spot suitable for shooting the landmark thus specified. According to the above method, it is possible to obtain similar effects to those of Aspect 1 or 6.

An image capturing apparatus according to one or more embodiments of the present invention may be realized by a computer. In this case, the present invention encompasses: a control program for image capturing which program causes a computer to operate as the foregoing sections (software elements) of the image capturing apparatus so that the image capturing apparatus can be realized by the computer; and a computer-readable storage medium storing the control program therein.

A control device for an image capturing apparatus according to one or more embodiments of the present invention may be arranged such that the control device includes a direction information identifying section (13) configured to, after the image capturing apparatus has moved to the spot suitable for shooting the landmark, identify (i) a range of shooting direction of the camera device and (ii) a direction to the landmark as seen from the spot suitable for shooting the landmark, and that the drive control section is configured to, after the image capturing apparatus has moved to the spot suitable for shooting the landmark, adjust an orientation of the image capturing apparatus so that the range of shooting direction thus specified and the direction to the landmark as seen from the spot suitable for shooting the landmark match each other. According to the above arrangement, it is possible to automatically cause the range of shooting direction of the camera device and the direction to the landmark as seen from the spot suitable for shooting the landmark to match each other, and therefore it is possible to save the user's trouble of having to adjust the orientation of the image capturing apparatus.

[Note]

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1a, 1b control device

2 memory device

3 location information obtaining device

6 camera device

7 driver device

8 movable part

10a, 10b robot (image capturing apparatus)

11 location identifying section

12 landmark information specifying section

13 direction information identifying section

14 drive control section

15 image obtaining section

17 person's position determining section

18 sound information generating section

1. A control device for an image capturing apparatus that includes a camera device, the control device comprising:
a location identifying section configured to identify a current location of the image capturing apparatus;
a landmark information specifying section configured to specify (i) a landmark for which a spot suitable for shooting the landmark is present at or near the current location and (ii) the spot suitable for shooting the landmark; and
a drive control section configured to cause the image capturing apparatus to move to the spot suitable for shooting the landmark thus specified.

2. The control device according to claim 1, wherein the landmark information specifying section is configured to reference landmark information, in which landmarks are associated with locations of the respective landmarks and with spots suitable for shooting the landmarks, to specify (i) the landmark for which the spot suitable for shooting the landmark is present at or near the current location and (ii) the spot suitable for shooting the landmark.

3. The control device according to claim 2, further comprising a direction information identifying section configured to, after the image capturing apparatus has moved to the spot suitable for shooting the landmark, identify (a) a range of vision that is seen in a captured image captured by the camera device and (b) a direction to the landmark as seen from the spot suitable for shooting the landmark,
the drive control section being configured to adjust an orientation of the image capturing apparatus so that the direction to the landmark as seen from the spot suitable for shooting the landmark is included in the range of vision that is seen in the captured image thus specified.

4. The control device according to claim 3, wherein the direction information identifying section is configured to reference (I) information indicative of the spot suitable for shooting the landmark and (II) information that is contained in the landmark information and that is indicative of a location of the landmark to identify the direction to the landmark as seen from the spot suitable for shooting the landmark.

5. The control device according to claim 1, further comprising:
an image obtaining section configured to obtain a captured image captured by the camera device;
a person's position determining section configured to, in a case where an image of a person is contained in the captured image thus obtained, determine whether or not a position of the person in the captured image is appropriate; and
a sound information generating section configured to, in a case where it is determined that the position of the person in the captured image is not appropriate, output sound information for guiding the person to move to an appropriate position.

6. An image capturing apparatus comprising:
at least one location information obtaining device;
at least one memory device;
at least one driver device;
at least one movable part;
at least one camera device; and
at least one control device,
the at least one memory device storing therein landmark information in which landmarks are associated with locations of the respective landmarks and with spots suitable for shooting the landmarks,
the at least one control device being configured to
identify a current location of the image capturing apparatus on the basis of current location information obtained by the at least one location information obtaining device,
specify, by referencing the landmark information stored in the at least one memory device, (i) a landmark for which a spot suitable for shooting the landmark is present at or near the current location and (ii) the spot suitable for shooting the landmark, and
cause, by causing the at least one driver device to instruct the at least one movable part to carry out an action, the image capturing apparatus to move to the spot suitable for shooting the landmark thus specified.

7. A method of controlling an image capturing apparatus that includes a camera device, the method comprising:
a location identifying step including identifying a current location of the image capturing apparatus;
a landmark information specifying step including specifying (i) a landmark for which a spot suitable for shooting the landmark is present at or near the current location and (ii) the spot suitable for shooting the landmark; and
a drive control step inducing causing the image capturing apparatus to move to the spot suitable for shooting the landmark thus specified.
